(19) United States
(12) Patent Application Publication
(10) Pub. No.: US 2015/0042187 A1
(43) Pub. Date: Feb. 12, 2015

(54) ENHANCED ELECTRONICS COOLING FOR ELECTRIC MACHINES

(71) Applicant: Remy Technologies, LLC, Pendleton, IN (US)

(72) Inventor: Michael D. Bradfield, Anderson, IN (US)

(21) Appl. No.: 13/961,460

(22) Filed: Aug. 7, 2013

(51) Int. Cl. H02K 1/20

(52) U.S. Cl. CPC H02K 1/20
USPC 310/59; 310/58

(57) ABSTRACT

An electric machine including a rotor and a stator operably coupled with the rotor, electronic components, and a drive shaft disposed along a central axis of the machine. A bearing support supportively surrounds the drive shaft, and a frame end is connected to the stator and has a backface portion to which the electronic components are mounted. The backface portion defines a frame airflow space through which cooling air can flow. The backface portion is sloped relative to the central axis and defines a frame air inlet through which cooling air is received into the frame airflow space, and the frame air inlet is located between the bearing support and the backface portion.

### CROSS-REFERENCE TO RELATED APPLICATION(S)

The present disclosure is related to the following filed patent applications: U.S. patent application Ser. No. 13/801,811, entitled HIGH EFFICIENCY B+ CONNECTION, filed Mar. 13, 2013 (Attorney Docket No. 22888-0073); U.S. patent application Ser. No. 13/801,908, entitled PHASE LEAD INSULATOR, filed Mar. 13, 2013 (Attorney Docket No. 22888-0074); and U.S. patent application Ser. No. ______, entitled ELECTRIC MACHINE HAVING VENTURI EFFECT COOLING ENHANCEMENT, filed ______ (Attorney Docket No. 22888-0075). The entire disclosures of all the above-listed patent applications are incorporated herein by reference.

### BACKGROUND

The present disclosure relates to improving efficiency of an electronic machine, particularly to thermal management in and around the electronic circuitry of the electronic machine.

Rotary electric machines include electric motors, alternators, electric generators, and devices that selectively operate as either an electric motor or generator. An alternator is a type of generator that includes a stationary stator and a rotor that rotates about an axis, and in which, during machine operation, a regulated direct current passes through the field winding of the rotor to induce an alternating current in the stator windings. Rectifier circuitry rectifies the alternating current to generate a direct current voltage that is compatible with the electrical system of a vehicle, most notably the vehicle battery.

Typically, rectifier circuits employ two diodes per stator phase to convert the alternating current flowing through the stator winding associated with a stator phase to a direct current voltage; the rectified DC voltage typically includes a corresponding voltage ripple. See generally, Bradfield, M., Improving Alternator Efficiency Measurably Reduces Fuel Costs, pgs. 9-12, http://www.delcoremy.com/documents/high-efficiency-white-paper.aspx, DelcoRemy, 2008.

Some rectifier circuits provide active rectification, also referred to as synchronous rectification, which employs MOSFET-based rectifier bridges integrated into a discrete electronic module or block to generate the direct current voltage. Although the MOSFET-based rectifier circuits minimize the high voltage drop and power consumption experienced with conventional diode rectifiers, resistive losses in the stator wires and the switching losses in the MOSFET-based electronic rectifier modules generate heat that, left unabated, can thermally stress and/or result in eventual failure of the electric machine. As a related problem, active rectifier circuits may include additional control circuitry which increases the overall package size of the discrete electronic blocks. Challenges arise in fitting such MOSFET-based rectifier circuits in smaller sized alternators.

Electric machines typically include a fan that generates airflow over or about the rectifier circuitry. In alternators, this airflow is commonly constrained by the air inlet size and shape, the size of the MOSFET-based electronic modules, and/or the rectifier bridge heat sinking arrangement, which typically funnels the airflow over a heat sink surface. The air exchange efficiency often suffers due to uneven loading caused by non-uniformly distributed air inlets. Also, air inlets located near the exhaust air outlets draw in and recirculate exhaust air through the electric machine, which increases the bulk temperature of cooling air passing over the rectifier circuitry. The net effect is to increase the operating temperature of the electronic machine, which may thermally stress components and decrease power efficiency. Id., pg. 23.

Accordingly, there is a need for an improved electric machine design that reduces thermal stress, increases the power efficiency of electric machines, and addresses machine electronic component considerations, particularly regarding space, power efficiency, and thermal issues associated with MOSFET-based active rectifiers in alternators.

### SUMMARY

The present disclosure addresses the above thermal management issues and shortcomings of prior electrical machines in connection therewith.

The present disclosure provides an electric machine including a rotor and a stator operably coupled with the rotor, electronic components, and a drive shaft disposed along a central axis of the machine. A bearing support supportively surrounds the drive shaft, and a frame end is connected to the stator and has a backface portion to which the electronic components are mounted. The backface portion defines a frame airflow space through which cooling air can flow. The backface portion is sloped relative to the central axis and defines a frame air inlet through which cooling air is received into the frame airflow space, and the frame air inlet is located between the bearing support and the backface portion.

A further aspect of this disclosure is that the backface portion is substantially frustoconical, and has opposing exterior and interior surfaces, the electronic components mounted to the backface portion exterior surface, the backface portion interior surface defining the frame airflow space, the frame air inlet disposed about the central axis.

An additional aspect of this disclosure is that the backface portion exterior surface is sloped relative to the central axis at an angle between about 20° and about 70°.

An additional aspect of this disclosure is that the backface portion exterior surface is sloped relative to the central axis at an angle between about 45° and about 70°.

An additional aspect of this disclosure is that the backface portion exterior surface is sloped relative to the central axis at an angle between about 50° and about 60°.

An additional aspect of this disclosure is that the backface portion interior surface is sloped relative to the central axis at an angle between about 10° and about 80°.

An additional aspect of this disclosure is that the backface portion interior surface is sloped relative to the central axis at an angle between about 15° and about 60°.

An additional aspect of this disclosure is that the backface portion interior surface is sloped relative to the central axis at an angle between about 25° and about 45°.

A further aspect of this disclosure is that the backface portion defines a radially inner rim at which the frame air inlet is located, the frame end includes a cylindrical portion connected to the backface portion and extending between the stator and the backface portion with frame air outlets located in the cylindrical portion, and the frame airflow space extends between the frame air inlet and the frame air outlets.

An additional aspect of this disclosure is that the frame air outlets are defined by a plurality of circumferentially distributed slots in the frame end, the slots having a first end located in the cylindrical portion and an opposite second end located in the frustoconical portion.

Furthermore, an aspect of this disclosure is that the machine includes a cover overlying the frame end and having a cover air inlet substantially surrounding the central axis through which cooling air is receivable into the machine. The cover and the frustoconical portion exterior surface define a cover airflow space extending between the cover air inlet and cover air outlets through which cooling air is receivable from the cover airflow space into the frame airflow space.

Another aspect of this disclosure is that the cover has a rim operably engaged with the frame end, the cover air outlets located between the frame air outlets and the slot second ends.

A further aspect of this disclosure is that the backface portion is sloped relative to the central axis at an acute angle.

A further aspect of this disclosure is that the frame air inlet defines a circumferential opening surrounding the central axis.

A further aspect of this disclosure is that the machine includes a cover connected to the frame end and defining a cover airflow space in which the electronic components are disposed and cover air outlets. The frame airflow space extends between the frame air inlet and a plurality of frame air outlets, each of the cover air outlets is paired with a respective one of the plurality of frame air outlets. The cover includes a cover air inlet through which is receivable a first portion of cooling air that is subsequently receivable into the frame airflow space and a second portion of cooling air that is subsequently receivable into the cover airflow space, and the first and second portions of cooling air are separated from each other between the frame air inlet and the cover air outlets.

An additional aspect of this disclosure is that the cover air inlet is disposed centrally with respect to a radial center of the machine.

An additional aspect of this disclosure is that the cover and frame end together define an airflow path for the first portion of cooling air that extends axially from the cover air inlet to the frame air inlet, then bends at an angle of less than 90° relative to the central axis within the frame airflow space while extending along the underside of the end frame to cool the electronic components, and then in combination with the second portion of cooling air is exhausted from the machine.

The present disclosure also provides an electric machine including a rotor and a stator operably coupled with the rotor. A drive shaft is disposed along a central axis of the machine, and a frame end is arranged at an end of the stator. The frame end includes a backface portion having electronic components mounted thereto, a bearing support structure in which the drive shaft is mounted, and frame air outlets that allow heated air to escape the machine. A cover is connected to the backface portion and overlies the backface portion. The cover includes a cover air inlet that allows cooling air to enter the machine, and the cover and the frame end define cover air outlets. A first airflow path extends from the cover air inlet to the frame air outlets, the first airflow path being aligned substantially parallel to the central axis at the location of the cover air inlet and having a bend of less than 90° relative to the central axis before terminating at the frame air outlets. A second airflow path extends from the cover air inlet to the cover air outlet through a cover airflow space in which the electronic components are located. The second airflow path exits the cover airflow space through the cover air outlets, and is brought into combination with the first airflow path at the cover air outlets.

A further aspect of this disclosure is that the backface portion is sloped relative to the central axis and the frame end defines a central airflow space between the backface portion and the bearing support structure in which the bend is located.

The present disclosure also provides a method of enhancing the cooling of electric components of an alternator of the type having a bearing support structure in which a drive shaft defining the alternator central axis is mounted and a frame end backface portion to which the electronic components are mounted, the method including sloping the backface portion relative to the central axis to thereby define a frame airflow space having a frame air inlet located between the backface portion and the bearing support structure through which air to cool the electronic components can flow.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 is a partially exploded perspective view of a first embodiment electric machine according to the present disclosure;

FIG. 2 is a partial, exploded perspective view of the electric machine depicted in FIG. 1;

FIG. 3 depicts a sectioned perspective view of the frame end member and the fan of the electric machine of FIG. 1;

FIG. 4 is a plan view of the axially inner side of the frame end member of the electric machine depicted in FIG. 1;

FIG. 5 is a plan view of the axially outer side of the frame end member of the electric machine depicted in FIG. 1;

FIG. 6A is an exploded perspective view of the baffle and frame end member of the electric machine depicted in FIG. 1;

FIG. 6B is an enlarged view of the portion of the baffle within encircled area B of FIG. 6A;

FIG. 6C is an enlarged view of the portion of the baffle within encircled area C of FIG. 6A;

FIG. 6D is a cross-sectional view the baffle portion shown in FIG. 6B along line D-D;

FIG. 6E is a cross-sectional view the baffle portion shown in FIG. 6C along line E-E;

FIG. 7 is a plan view of the axially outer side of the frame end member of the electric machine similar to FIG. 5, also showing the installed baffle;

FIG. 8 is a perspective view of the frame end member and installed baffle of FIG. 7;

FIG. 9A is a fragmented, partial cross-sectioned view of a prior electric machine, wherein the frame airflow space is defined by a frame end member portion that is oriented substantially perpendicularly relative to the machine central axis;

FIG. 9B is a fragmented, partial cross-sectioned view of an embodiment of an electric machine according to the present disclosure, wherein the frame airflow space is defined by a frame end member portion that is obliquely oriented relative to the machine central axis;

FIG. 9C is a fragmented, partial cross-sectioned view, similar to that of FIG. 9B, of an alternative embodiment of an electric machine according to the present disclosure

FIG. 9D is an enlarged view of the electric machine as depicted in FIG. 9C;

FIG. 9E is a different cross-section of the electric machine shown in FIG. 9C, with its illustrated rectifier MOSFET omitted;

FIG. 10 is a partially sectioned, perspective view of a portion of the electric machine shown in FIG. 1;

FIG. 11 is a perspective view of a portion of the electric machine of FIG. 1 with the cover installed;

FIG. 12 is a perspective view similar to FIG. 11 showing a second embodiment of an electric machine according to the present disclosure;

FIG. 13 is a perspective view similar to FIG. 11 showing a third embodiment of an electric machine according to the present disclosure;

FIG. 14 is a perspective view similar to FIG. 12 showing a fourth embodiment of an electric machine according to the present disclosure; and

FIG. 15 is a perspective view similar to FIG. 11 showing a fifth embodiment of an electric machine according to the present disclosure.

Corresponding reference characters indicate corresponding parts throughout the several views. Although the drawings represent embodiments of the disclosed device and method, the drawings are not necessarily to scale or to the same scale and certain features may be exaggerated in order to better illustrate and explain the present disclosure. Moreover, in accompanying drawings that show sectional views, cross-hatching of various sectional elements may have been omitted for clarity. It is to be understood that any omission of cross-hatching is for the purpose of clarity in illustration only.

### DETAILED DESCRIPTION OF EXEMPLARY EMBODIMENT(S)

The embodiments described below are not intended to be exhaustive or to limit the invention to the precise forms disclosed in the following detailed description. Rather, the embodiments are chosen and described so that others skilled in the art may appreciate and understand the principles and practices of the present invention.

Each exemplary electric machine described herein is an alternator or AC generator, but it is to be understood that the teachings of the present disclosure may also be applied to other types of electric rotary machines, such as electric motors or DC generators, for example. Electric machine 20 includes housing 22, frame assembly 24 including frame end member 26 which is attached to housing 22 by fasteners 28, and cover 30 having central air inlet 32. Central air inlet 32 of cover 30 includes a plurality of cover air inlet openings 34. Frame end member 26 may be cast, molded, or otherwise formed of a rigid, thermally conductive material such as an aluminum alloy. Cover 30 is injection molded from a suitably rigid but somewhat pliable, thermally stable thermoplastic.

Cover 30 is secured to frame end member 26 in a suitable, well-known manner, such as by screws (not shown) or elastically deformable interlocking tabs (not shown). Cover 30 engages frame assembly 24 to form a plurality of cover air outlets 36, and cover airflow space 38 which is located between cover air outlets 36 and cover air inlet 32. Frame end member 26 defines central airflow space or passage 40 having frame air inlet 42, a plurality of frame air outlets 44, and frame airflow space 46 located between frame air inlet 42 and frame air outlets 44.

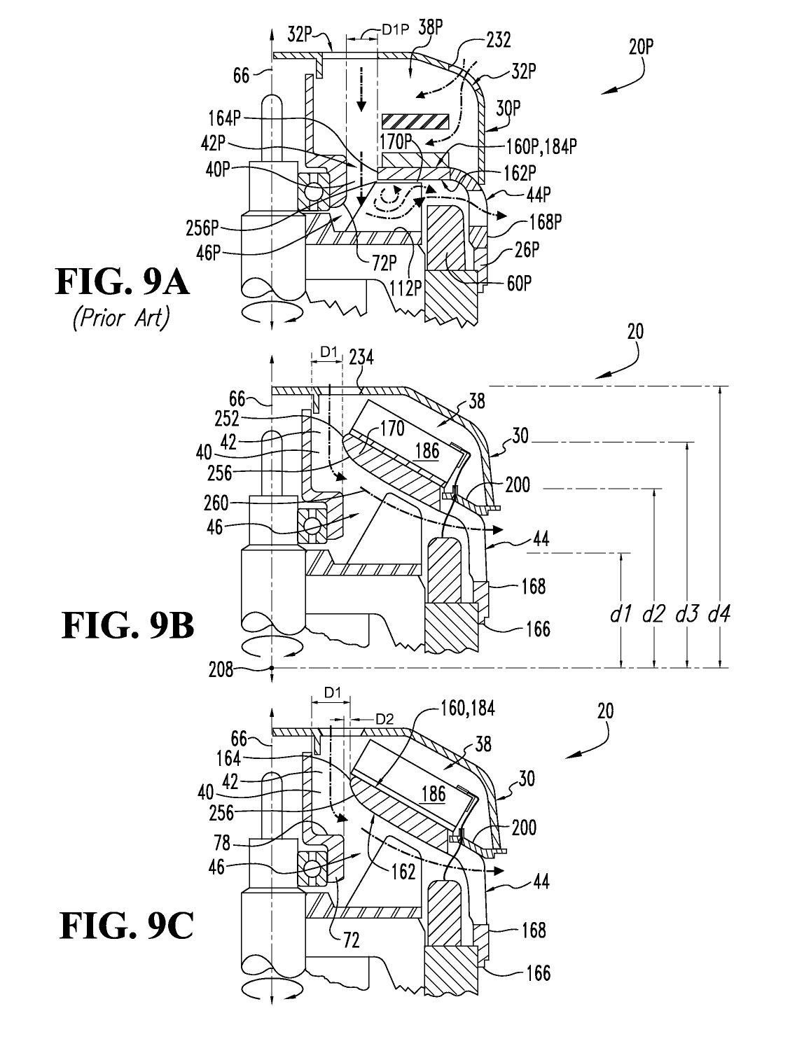

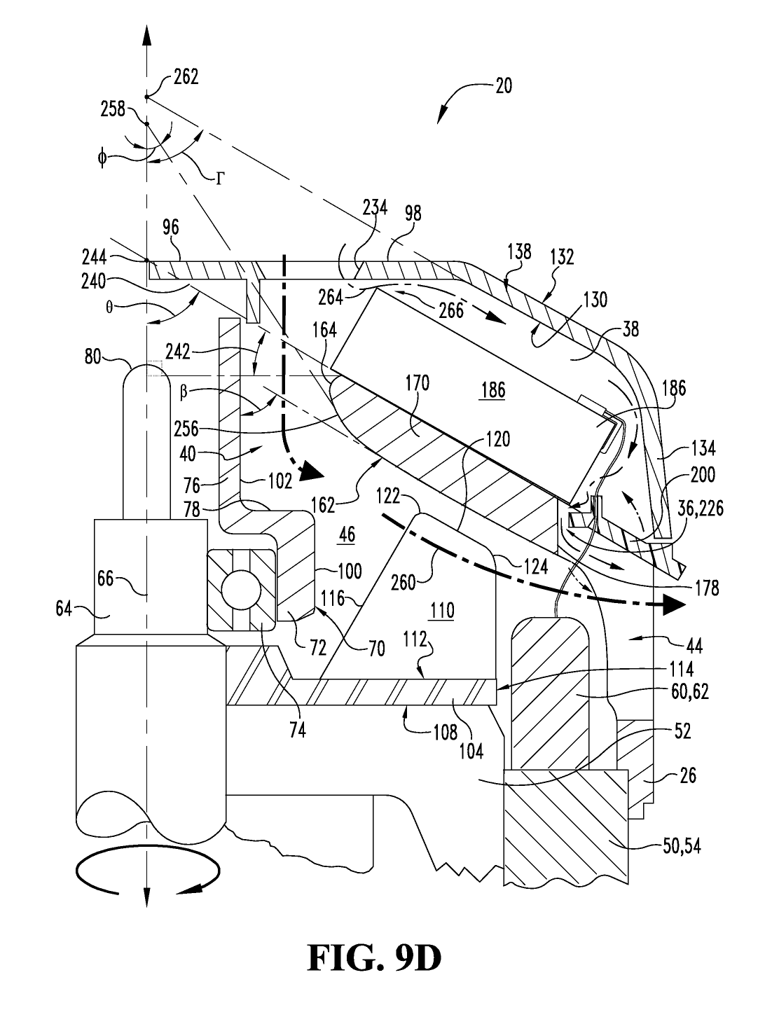

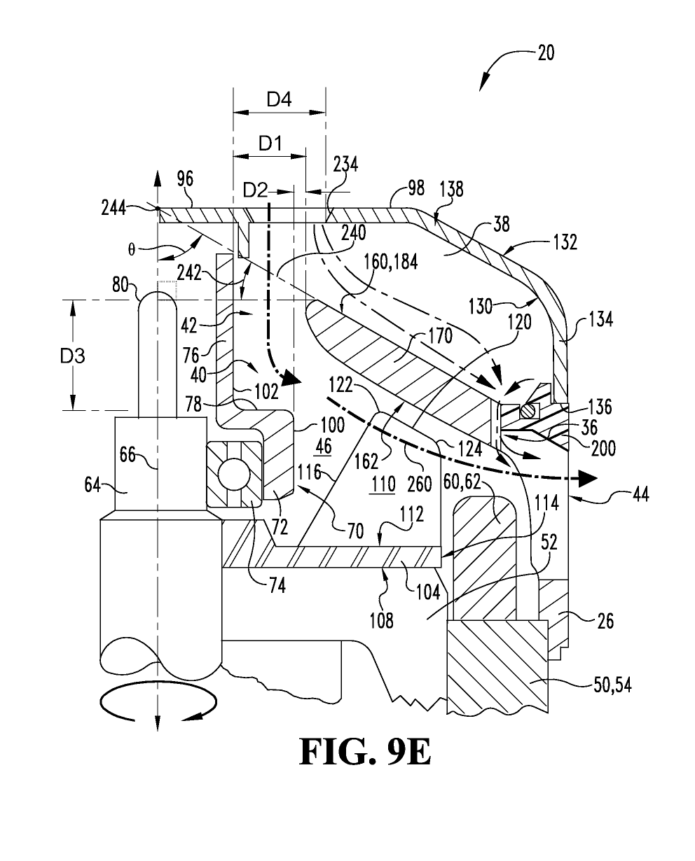

Machine 20 further includes annular stator 50 fixed to surrounding housing 22, and generally cylindrical rotor 52 surrounded by stator 50. Stator 50 includes stator core 54 having stator teeth (not shown) between which are received longitudinal segments (not shown) of stator windings 60 which have end turnings 62 located axially outside of stator core 54, as shown in FIG. 9D. Rotor 52 is fixed to driveshaft 64 which extends along and is rotatable about machine central axis 66. Driveshaft 64 and rotor 52 are supported for rotation relative to housing 22, stator 50, and frame assembly 24, by frame assembly 24. Certain features of rotor 52 and stator 50, such as their respective cores, field coils, etc., are well within the understanding of those having ordinary skill in the art but beyond the scope of the present disclosure, and thus are omitted from some or all of the drawings. In a manner well-understood by those of ordinary skill in the art, stator 50 and rotor 52 are operably coupled during operation of machine 20, be it a generator or motor, via electromagnetic flux therebetween.

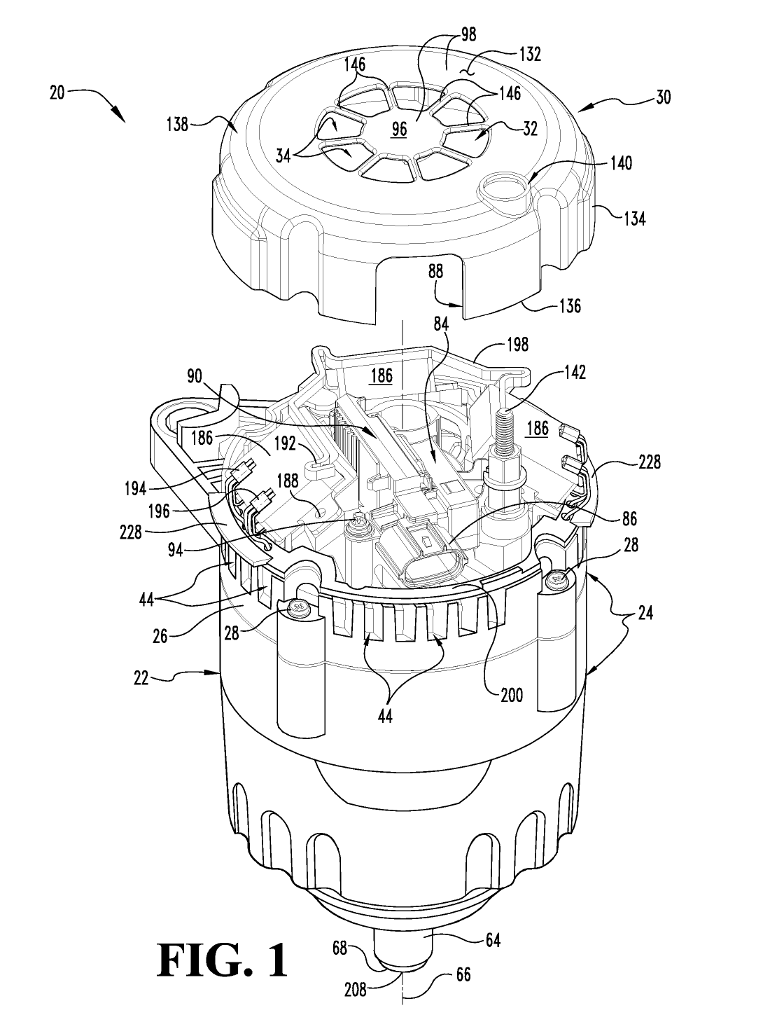

Axial and radial directions mentioned herein are relative to central axis 66, i.e., axial directions are parallel, and radial directions are perpendicular, to axis 66. Moreover, characterizations as top or bottom are arbitrary, but defined with respect to the orientation of machine 20 (e.g., alternator 20) as shown in FIG. 1. With regard to its typical, horizontal operating orientation, the designated “top” of alternator 20 would also be referred to as its rear, and its designated “bottom” would also be referred to as its front. With regard to the views of the accompanying drawings, directions or characteristics designated as axially outer or outward are rearward, i.e., away from driveshaft first end 68, or upward relative to the orientation shown in FIG. 1; and directions or characteristics designated as axially inner or inward are forward, towards driveshaft first end 68, or downward relative to the orientation shown in FIG. 1.

Referring to FIGS. 9D and 9E, frame end member 26 includes integrally formed bearing support 70 having generally cylindrical bearing housing portion 72 in which shaft-supporting bearing 74 is disposed, and coaxial, generally cylindrical neck portion 76 of relatively smaller diameter. Between bearing housing portion 72 and neck portion 76 is defined annular shoulder 78. Neck portion 76 extends axially upward from shoulder 78 along central axis 66. Driveshaft second end 80 is disposed within bearing support neck portion 76 and is provided with a pair of axially spaced slip rings (not shown) that are electrically connected to the field coil (not shown) of rotor 52. Application of a regulated DC voltage across the slip rings generates a magnetic field of variable strength that rotates with rotor 52 about axis 66 and induces current in stator windings 60 in a manner well-known to those of ordinary skill in the art.

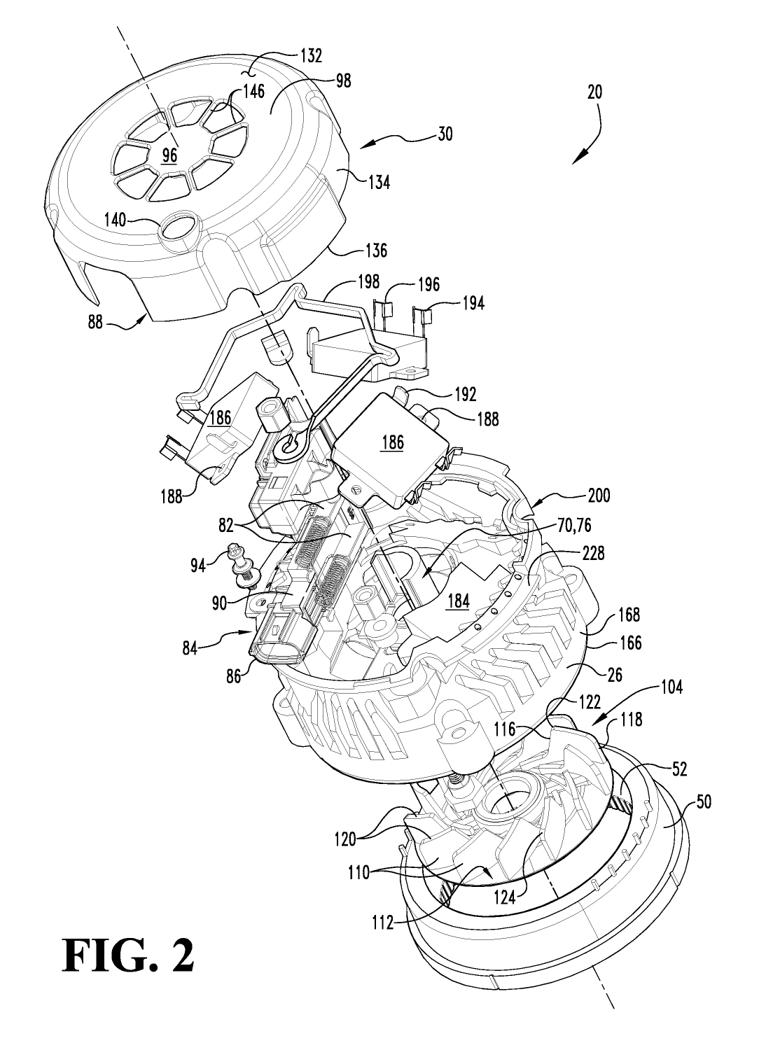

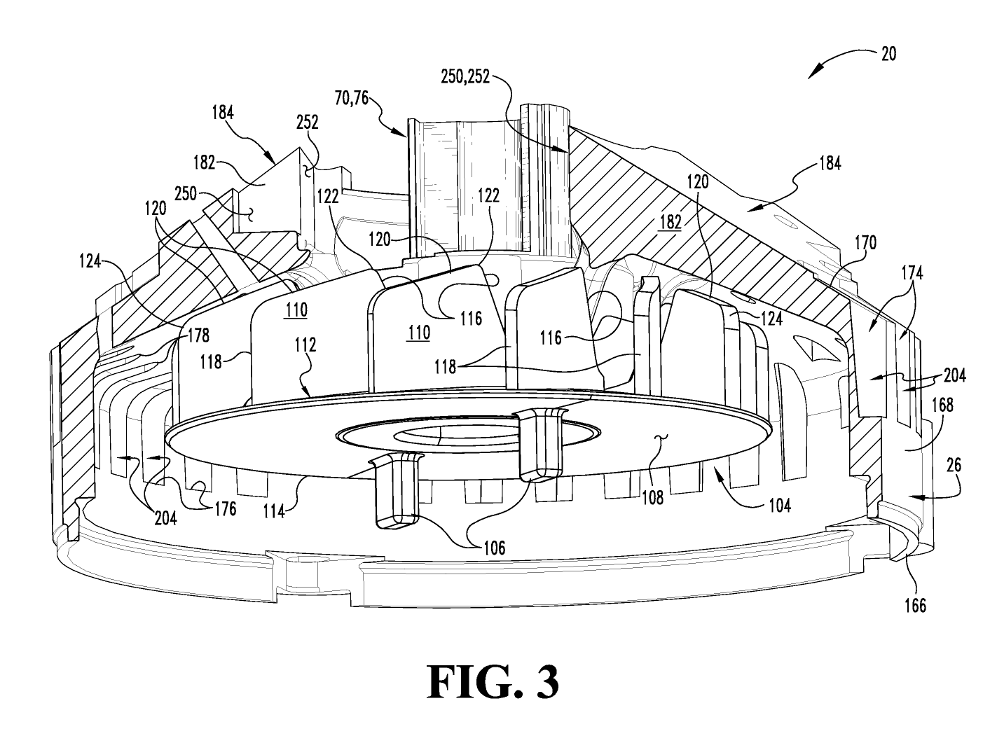

As best seen in FIGS. 2 and 3, along its length, the cylindrical wall of bearing support neck portion 76 is not circumferentially continuous; a portion is omitted to accommodate the engagement of a pair of brushes 82 of a brush holder/regulator assembly 84 to the slip rings. Brush holder/regulator assembly 84 is affixed to frame end member 26 and brushes 82 are spring-biased into sliding electrical contact with a respective slip ring in a manner well-known in the relevant art. Brush holder/regulator assembly 84 includes electrical connector housing 86 which is accessible from outside of machine 20 and extends through recess 88 provided in the circumferential wall of cover 30. Brush holder/regulator assembly 84 also includes regulator master 90 affixed in thermally conductive contact with regulator heat sink portion 92 of frame end member 26 with fasteners 94. Brush holder/regulator assembly 84 is thus disposed beneath cover 30 and within cover airflow space 38. The axially outer end of bearing support 70 is covered by central portion 96 of cover top wall 98, about which cover central air inlet 32 is located. Cover air inlet 32 is generally aligned with central airflow passage 40, which is located about outer cylindrical surfaces 100, 102 of bearing support housing portion 72 and bearing support neck portion 76, respectively, as best seen in FIGS. 9B-9E and discussed further below.

Within frame airflow space 46 is centrifugal fan 104 disposed about driveshaft 64 between bearing support 70 and rotor 52. Fan 104 rotates in unison with rotor 52 and driveshaft 64, and may be rotatably coupled directly to driveshaft 64 or to rotor 52. As can be understood from FIG. 3, fan 104 as depicted is keyed to rotor 52 through bosses 106 that project axially from fan planar bottom surface 108 and are received into cooperating recesses (not shown) provided in rotor 52.

Fan 104 draws air into cover air inlet 32 and through central airflow passage 40. Fan 104 is generally circular, and includes a plurality of fan blades 110 integrally attached to fan face 112, which may be substantially planar as shown, or generally frustoconical. Fan blades 110 generally extend to circular outer edge 114 of fan face 112. Cooling air moves towards fan 104 generally along the axial direction, and is expelled from rotating fan 104 in radial directions, in a manner well-known in the art. Fan blades 110 may be curved, as shown in FIG. 2, or straight, and each includes leading edge 116, trailing edge 118, and top edge 120 located between leading and trailing edges 116, 118, as best seen in FIGS. 2, 3, 9D, and 9E. As shown, leading edge 116 and top edge 120 converge to form fan blade apex 122. Fan blade apex 122 may be axially located at different positions relative to bearing support shoulder 78. Top edge 120 slopes radially outward and axially inward from apex 122, to form obtusely angled corner 124 with trailing edge 118 at a location axially inward of bearing support shoulder 78. Each top edge 120 may extend along a straight line between apex 122 and corner 124, or along a curved line therebetween. As can be understood from FIG. 2, each fan blade 110 may also be curved between its leading and trailing edges 116, 118 in an imaginary plane perpendicular to central axis 66.

Cover 30 has interior surface 130 and exterior surface 132 which define generally cylindrical cover side wall 134. Cover side wall 134 extends between generally circular, axially inner rim 136 and generally frustoconical portion 138 of cover 30. Cover frustoconical portion 138 extends between cylindrical side wall 134 and cover top wall 98 which, as mentioned above, includes central air inlet 32 and top wall central portion 96. As discussed further below, cover rim 136 sealably engages portions of frame end member 26 to form cover air outlets 36. Cover 30 also includes axially outwardly projecting collar 140 located in frustoconical portion 138 that defines an opening through which projects alternator B+ terminal 142, which is externally accessible for connection to the vehicle battery (not shown) in a well-known manner.

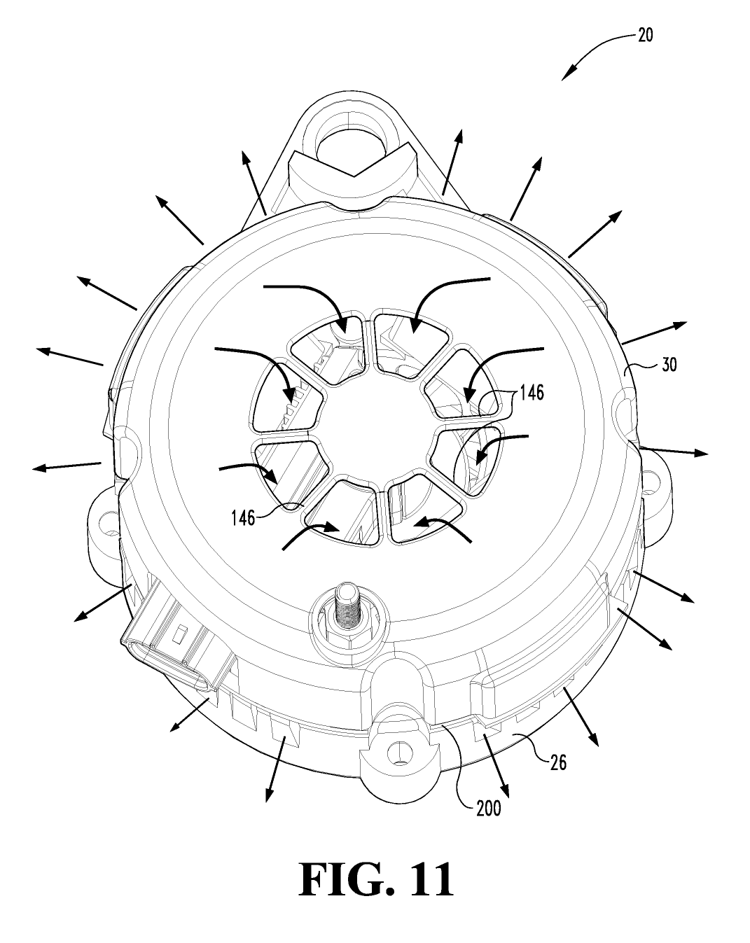

The interior of bearing support 70 is substantially enclosed at its axially outer end by cover 30. The portion of cover interior surface 130 defined by top wall central portion 96 is provided with axially inwardly projecting annular collar 144 that continually surrounds the open, axially outer end of cylindrical bearing support neck portion 76, which is covered by top wall central portion 96. Top wall central portion 96 is joined to the surrounding portion of cover top wall 98 a plurality of radially extending connecting members 146 that define the plurality of cover inlet openings 34, as shown in FIGS. 1, 2, and 11. Other than inlet openings 34, cover 30 is preferably bereft of voids through which air may be drawn into machine 20, particularly recirculated air that has previously been exhausted from the machine.

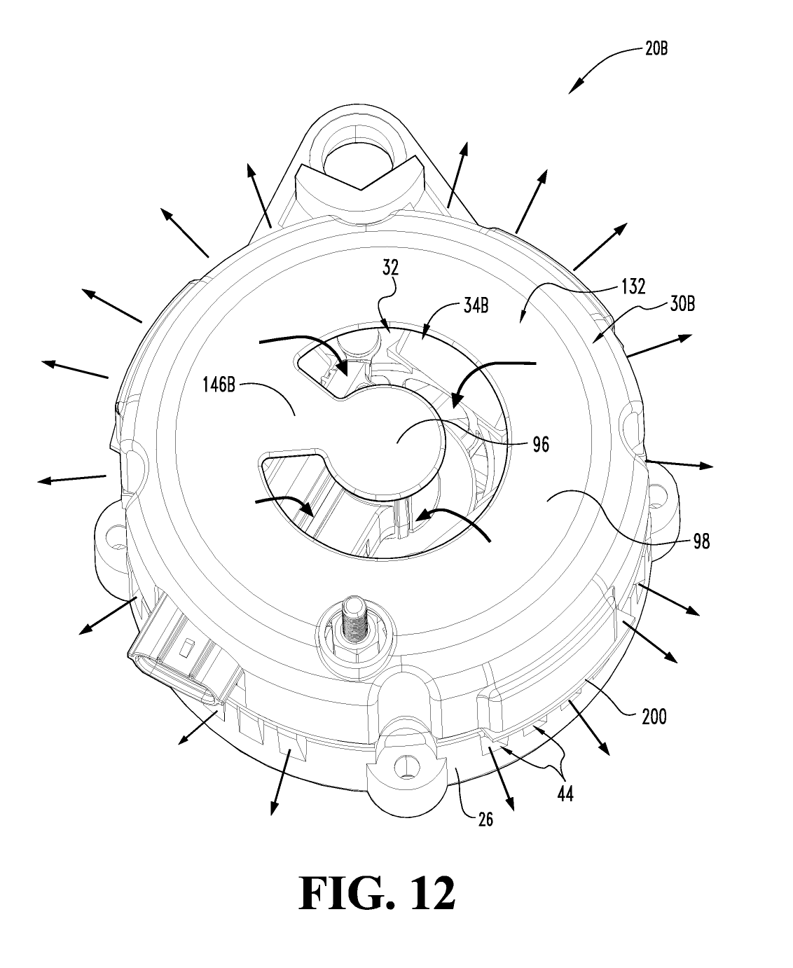

Alternative electric machine embodiments having respectively different cover configurations are now described with reference to FIGS. 12-15.

Except as described herein or depicted in the drawings, second embodiment machine 20B, a portion of which is shown in FIG. 12, has a structure, function, operation, and interrelationships between components that are substantially identical to those of first embodiment machine 20. Machine 20B includes cover 30B in which, as shown, its central air inlet 32 is defined by a single, C-shaped opening 34B that extends about cover top wall central portion 96. In cover 30B, top wall central portion 96 is joined to the surrounding portion of cover top wall 98 through a single radially extending connecting member 146B that is relatively wider circumferentially about central axis 66 than any one of the above-mentioned plurality of radially extending connecting members 146 of cover 30. Other than inlet opening 34B, cover 30B is preferably bereft of voids through which air may be drawn into machine 20B, particularly recirculated air that has previously been exhausted from the machine.

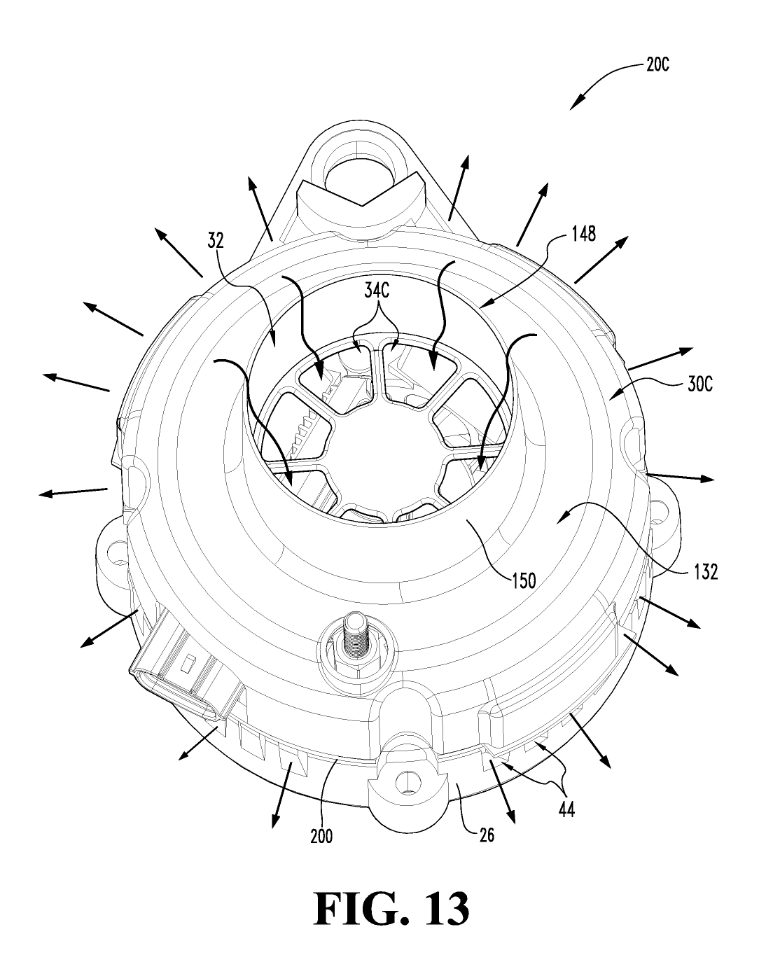

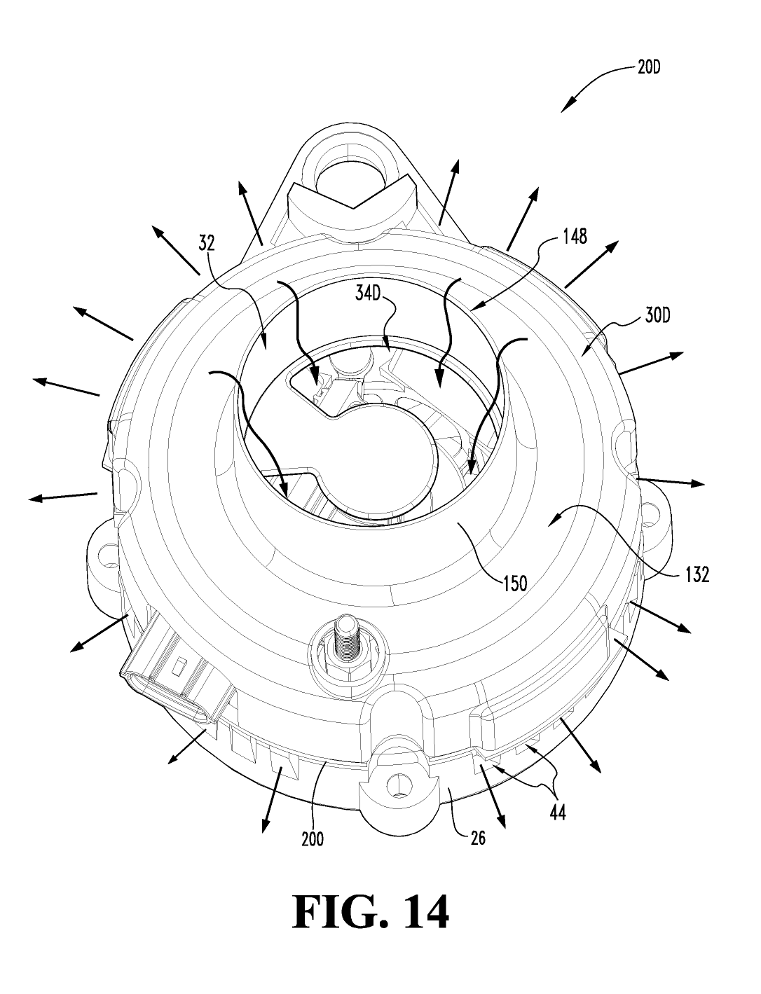

Except as described herein or depicted in the drawings, third and fourth embodiment machines 20C and 20D, portions of which are shown in FIGS. 13 and 14, each have a structure, function, operation, and interrelationships between components that are substantially identical to those of first and second embodiment machines 20 and 20B, respectively. Machines 20C and 20D respectively include cover 30C or 30D in which, as shown, central air inlet 32 includes cylindrical wall 148 within which cover air inlet opening(s) 34C, 34D (which may be respectively identical to air inlet opening(s) 34, 34B) are located. Cylindrical wall 148 is coaxial with central axis 66 and projects axially outwardly from cover exterior surface 132. Cylindrical wall 148 is an integrally molded portion of cover 30C, 30D, and may be open to the ambient air to receive cooling air directly into central air inlet 32; preferably, however, cylindrical wall 148 provides its cover 30C, 30D with a sealable fitting for interconnection with the outlet of a cooling air duct (not shown), to provide machines 20C, 20D with a ducted cover air inlet 32. The interconnection between the cover central air inlet 32 and the cooling air duct outlet may involve a clamped joint in which, for instance, the duct outlet encircles and is retained in compressive engagement with radially outer surface 150 of cylindrical wall 148 by a band clamp (not shown) or other suitable means for interconnecting the duct and the cover.

In applications of machine 20C or 20D wherein cover central air inlet 32 is ducted, it is preferable that the inlet (not shown) of the cooling air duct connectable to cover air inlet 32 be remote from frame air outlets 44 and other heat sources. The cooling air duct may extend from cover 30C, 30D to a location at which the duct inlet is provided with a source of cooling air that is distant from frame air outlets 44 and other sources of heat, and also protected against direct road splash, thereby better protecting against cooling air recirculation and the ingestion of water and other contaminants such as road salt into the machine's airflow spaces 38, 46. Other than its inlet opening(s) 34C, 34D, cover 30C or 30D is preferably bereft of voids through which air may be drawn into machine 20C, 20D, particularly air that has previously been exhausted from frame air outlets 44 and might otherwise be recirculated through the machine.

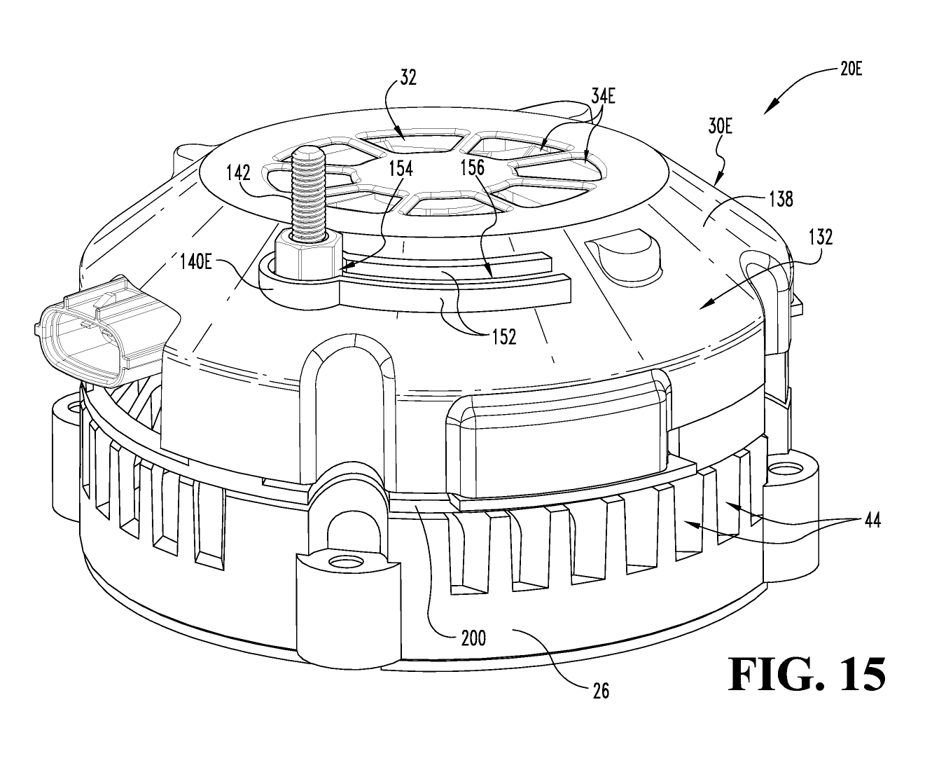

Except as described herein or depicted in the drawings, fifth embodiment machine 20E, a portion of which is shown in FIG. 15, has a structure, function, operation, and interrelationships between components that is substantially identical to those of first embodiment machine 20. Machine 20E includes cover 30E in which the axially outwardly extending collar surrounding B+ terminal 142 is modified to better facilitate routing of the electrical cable (not shown) connectable to terminal 142. Cover 30E includes axially outwardly extending collar 140E which non-continuously surrounds the cover opening through which B+ terminal 142 projects. A pair of parallel guide walls 152 is integrally molded onto the exterior surface 132 of cover generally frustoconical portion 138. Guide walls 152 extend circumferentially partially about axis 66 and cover air inlet 32 from recess 154 in collar 140E, and define guide channel 156 that communicates with the cover B+ terminal opening through recess 154. The electrical cable (not shown) connectable to B+ terminal 142 is receivable between guide walls 152, and routed along and retained within guide channel 156. Other than air inlet openings 34E, which may be identical to air inlet opening(s) 34 (as shown) or 34B, cover 30E is preferably bereft of voids through which air may be drawn into machine 20E, particularly recirculated air that has previously been exhausted from the machine. Central air inlet 32 of cover 30E may include a cylindrical wall 148 similar to that included in cover 30C or 30D and may or may not be a ducted air inlet.

In each of machines 20, 20B, 20C, 20D, and 20E, the respective cover central air inlet 32 is located about and near central axis 66 to maximize its distance from frame air outlets 44. Thus, the management of cooling air in accordance with the present disclosure reduces the possibility of cooling air recirculation, and facilitates a minimal average bulk temperature of cooling air entering the cover air inlet 32.

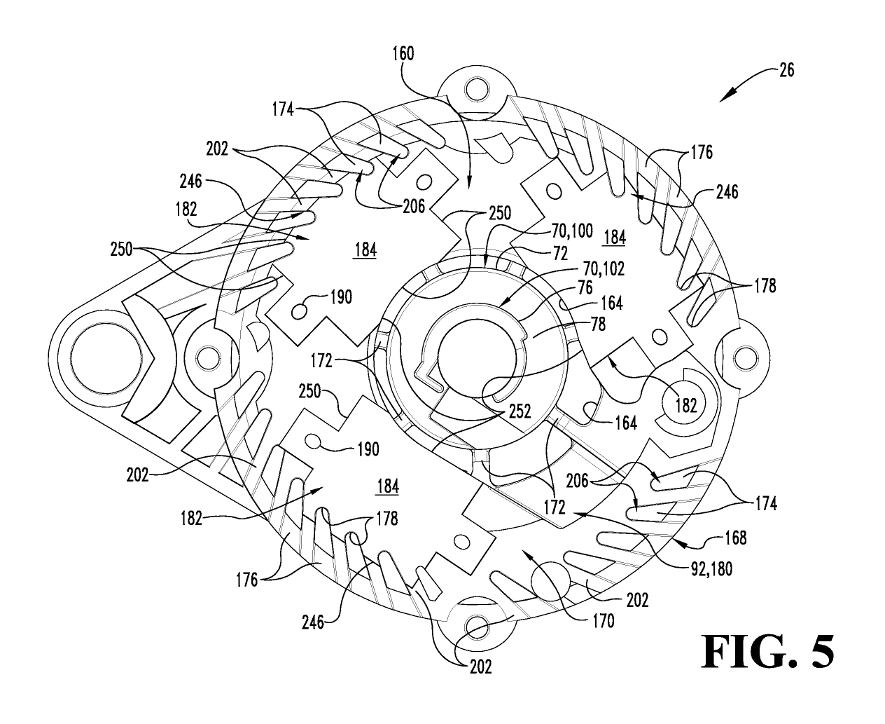

Returning now to machine 20 in describing other, common aspects of machines 20, 20B, 20C, 20D, and 20E, FIGS. 3-5 show that frame end member 26 has axially outwardly facing frame exterior surface 160, axially inwardly facing frame interior surface 162, annular radially inner rim 164, and annular radially outer rim 166. Frame radially outer rim 166 engages housing 22, and is secured thereto with a plurality of bolts in a well-known manner. Frame end member 26 includes cylindrical portion 168 that extends axially outwardly from radially outer rim 166, and frustoconical backface portion 170 that extends axially outwardly and radially inwardly from cylindrical portion 168 to radially inner rim 164. Frame end member cylindrical and frustoconical portions 168, 170 define wall portions of frame assembly 24 and airflow spaces through machine 20. In some embodiments, superposed portions of exterior surface 160 and interior surface 162 are substantially parallel in directions through the thickness of frustoconical portion 170; in other embodiments, these superposed portions of surfaces 160 and 162 are nonparallel.

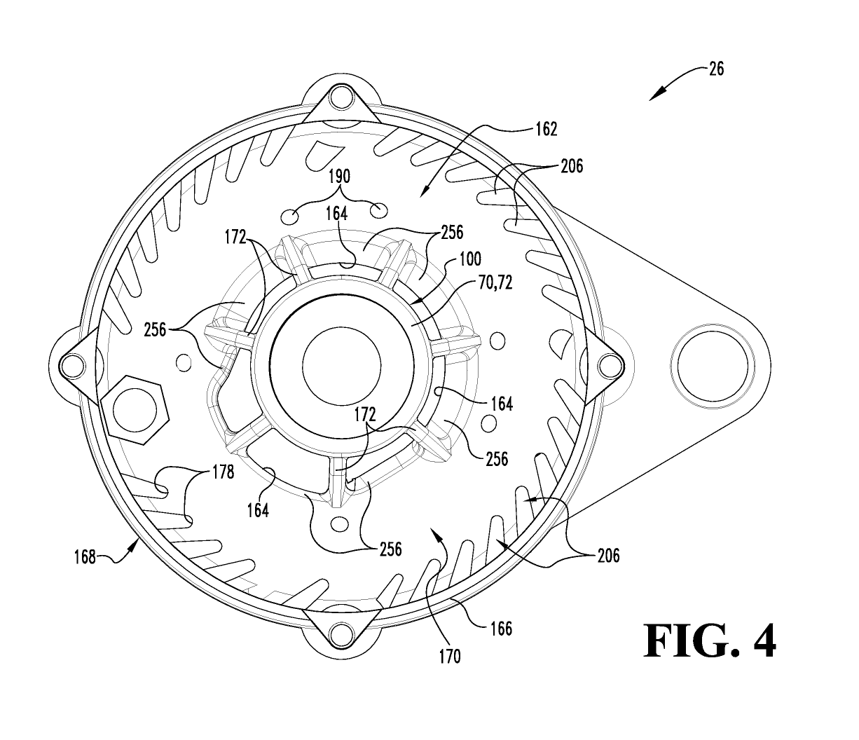

Bearing support 70 is joined to frustoconical portion 170 through a plurality of circumferentially spaced support members 172, as best seen in FIG. 4. Support members 172 traverse central airflow passage 40. Axially outward of bearing support shoulder 78, bearing support neck portion 76 is surrounded at locations long its length by frame radially inner rim 164, as best shown in FIGS. 9B-9E. A radial clearance D1 between neck portion cylindrical surface 102 and the frame radially inner rim 164 defines frame air inlet 42, as indicated in FIGS. 9B and 9E.

Frame end member 26 is provided with a circumferentially distributed arrangement of elongate slots 174 each having a first end 176 located in frame cylindrical portion 168 and a second end 178 located in frame frustoconical portion 170. Slots 174 may be of substantially uniform size and shape, and symmetrically located about the periphery of frame end member 26. Slots 174 each extend between opposite first and second ends 176, 178 and completely through the thickness of frame end member 26, i.e., between its exterior and interior surfaces 160, 162. Both cover air outlets 36 and frame air outlets 44 are defined by slots 174, as discussed further below.

Generally frustoconical frame exterior surface 160 includes above-mentioned regulator heat sink portion 92, which is provided with mounting surface 180 radially aligned with the omitted portion of cylindrical bearing support neck portion 76. Brush holder/regulator assembly 84 is affixed to mounting surface 180 such that regulator master 90 and mounting surface 180 are in thermally conductive contact. Heat conductively transferred from brush holder/regulator assembly 84 through mounting surface 180 is absorbed by heat sink portion 92, and generally by frame end member 26, and is convectively transferred to the cooling airflow through machine 20, as described herein.

Frame exterior surface 160 also includes a plurality of heat sink portions 182 (e.g., three, as shown), each defining a mounting surface 184. Each mounting surface 184 is generally planar, and has an electronics module 186 affixed thereto in thermally conductive contact, as by threaded fasteners (not shown) that extend through clearance holes 188 in modules 186 and are received in threaded holes 190 of each heat sink portion 182. Heat transferred conductively from modules 186 to mounting surfaces 184 is absorbed by heat sink portions 182, and generally by frame end member 26, and is convectively transferred to the cooling airflow through machine 20, as described herein.

Referring to FIGS. 1, 2, and 10, in alternator 20 electronic modules 186 include circuitry that rectifies an alternating current signal induced in stator windings 60 in response to the rotation of rotor 52. Although the particular characteristics of the MOSFETs or their rectifying circuitry are beyond the scope of the present disclosure, those of ordinary skill in the relevant art will understand that the circuitry may include H-Bridge rectifier circuitry or half H-Bridge rectifier circuitry. The rectifier circuitry of each MOSFET is coupled to the module's supply terminal 192, first phase signal terminal 194, and second phase signal terminal 196, which provide electrical contacts external to the module. First phase signal terminal 194 and second phase signal terminal 196 are crimped and soldered to respective wires of stator windings 60. Once these connections are completed, first and second phase signal terminals 194, 196 are bent into close proximity to the top surface of their respective modules 186. Supply terminals 192 are crimped and soldered to coupling bends formed in supply bus 198, which may be a unitary strip of copper electrically connecting all supply buses 198 and B+ terminal 142.

Preferably, baffle 200 is located between cover axially inner rim 136 and frame end member frustoconical portion 170. Baffle 200 may be similar to the phase lead insulator referred to in above-mentioned U.S. patent application Ser. No. 13/801,908, entitled PHASE LEAD INSULATOR, filed Mar. 13, 2013, the disclosure of which is incorporated herein by reference. Baffle/phase wire insulator 200 (identified by reference numeral 48 in the incorporated reference) is a circumferential ring formed of a flexible, electrically insulative, compressible material. On frame exterior surface 160, between adjacent slots 174, are baffle ledge portions 202 positioned on frustoconical portion 170 between ends 176, 178 of circumferentially arranged slots 174. Baffle 200 extends continuously about the radially outer periphery of frame frustoconical portion 170, with its bottom surface alternatingly traversing slots 174 and abutting ledge portions 202. Cover rim 136 is placed in abutting contact with the top surface of baffle 200 and, with cover 30 secured to frame end member 26, baffle 200 is compressed between cover rim 136 and baffle ledge portions 202.

Each elongate slot 174 has first and second portions 204, 206 that are respectively defined by opposite first and second slot ends 176, 178. First slot portions 204 are in fluid communication with frame airflow space 46 and define frame air outlets 44. Second slot portions 206 are in fluid communication with both frame airflow space 46 and cover airflow space 38 and define cover air outlets 36. The separation between first and second slot portions 204, 206 is defined by baffle 200. With regard to most slots 174, this occurs at the juncture of cover axially inner rim 136 and frame end member exterior surface 160, which is located along those slots 174 between their respective slot ends 176, 178, where baffle 200 traverses the respective slot 174. Thus, baffle 200 is disposed between cover 30 and frame exterior surface 160, and cover 30 sealably engages frame end member 26 through baffle 200 at baffle ledge portions 202. Accordingly, cover 30 operatively engages the top surface of baffle 200 to form cover airflow space 38, which is located between cover interior surface 130 and frame exterior surface 160.

Baffle 200, the edges of first slot portions 204, and cover 30 which engages frame end member 26 through baffle 200, define frame air outlets 44 through which cooling air is radially exhausted from frame airflow space 46 to ambient space outside of machine 20. Baffle 200, the edges of second slot portions 206, and cover 30 which engages frame end member 26 through baffle 200, define cover air outlets 36 through which cooling air is drawn from cover airflow space 38 into frame airflow space 46. Thus, cover 30 sealably engages frame end member 26 to form cover air outlets 36 and frame air outlets 44, with each cover air outlet 36 paired with a respective one of frame air outlets 44 through their common slot 174. The passage of cooling air from cover airflow space 38 is thus limited to entry into frame airflow space 46, and the sealed engagement of cover rim 136 to baffle ledge portions 202 helps to prevent the recirculation of cooling air exhausted through frame air outlets 44, back into cover airflow space 38 at locations along the interface between cover rim 136 and baffle ledge portions 202. Notably, as shown in FIGS. 9D and 9E, interior surface 162 of frame end member frustoconical portion 170 defines an acute angle with slot second end 178, whereby the flow of cooling air in frame airflow space 46 approaching frame air outlets 44 from fan 104 is not diverted into cover air outlets 36, but instead flows past cover air outlets 36.

Reference point 208 may be chosen along central axis 66 axially inward of frame end member 26, and therefore axially inward of slot first ends 176. For example, reference point 208 may be located at first end 68 of driveshaft 64 or perhaps, near the center of rotor 52. From the axial position of reference point 208, in an axially outward direction parallel to central axis 66, frame air outlets 44 are located at first distance d1; cover air outlets 36 are located at second distance d2; frame air inlet 42 is located at third distance d3; and cover air inlet 32 is located at fourth distance d4. The relative locations of cover air inlet 32, cover air outlets 36, frame air inlet 42, and frame air outlets 44 may thus be described with reference to FIG. 9B: First distance d1 (of frame air outlet(s) 44) is smaller than second distance d2 (of cover air outlet(s) 36); second distance d2 is smaller than third distance d3 (of frame air inlet 42); and third distance d3 is smaller than fourth distance d4 (of cover air inlet 32); i.e., d1<d2<d3<d4. Additionally, cover air inlet 32 and frame air inlet 42 are both radially inward of both cover air outlets 36 and frame air outlets 44, and cover air outlets 36 are radially inward of frame air outlets 44.

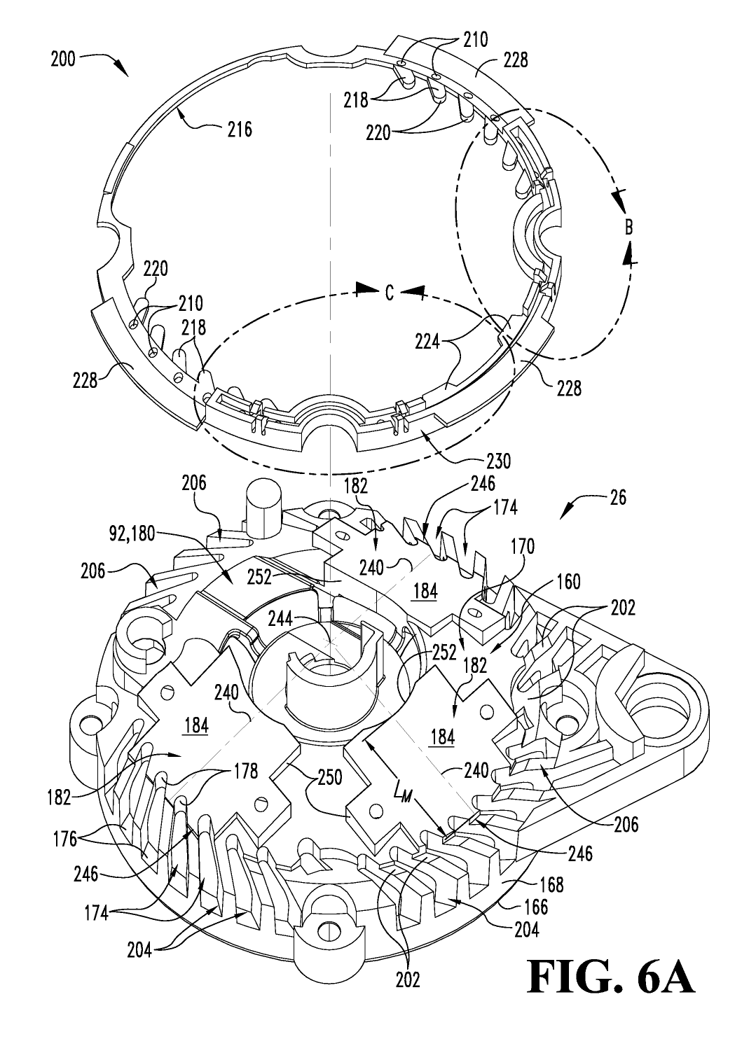

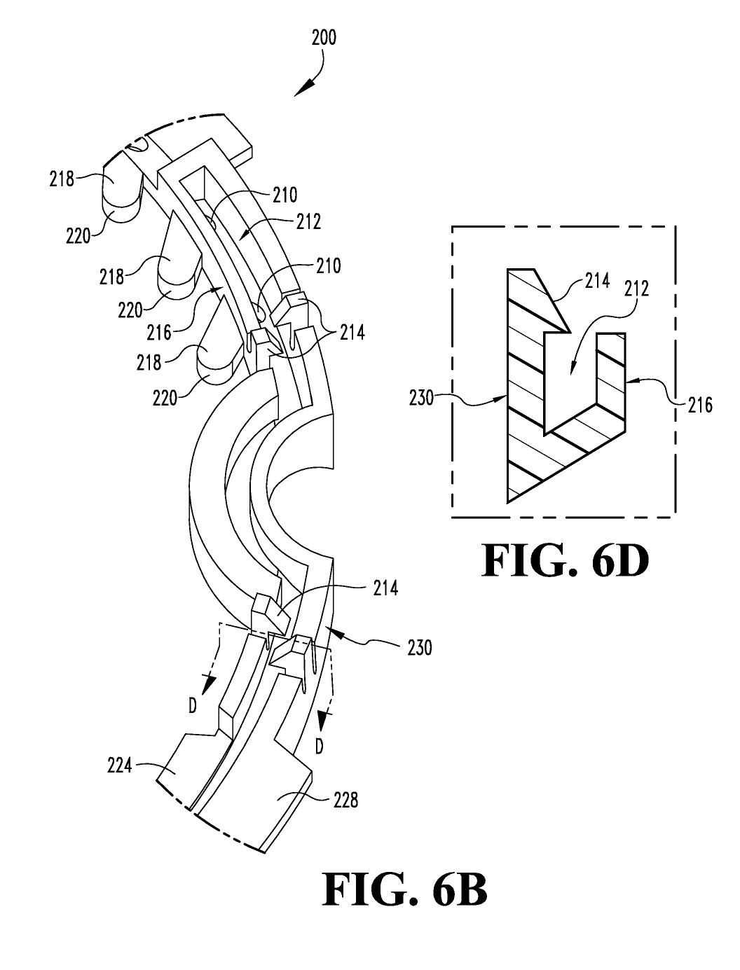

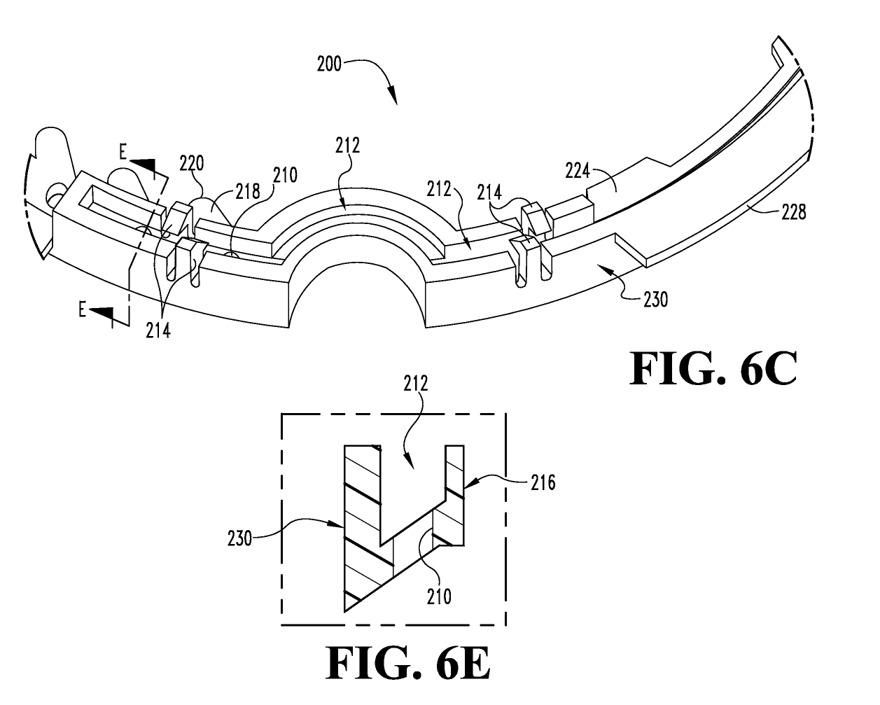

Referring to FIGS. 6A-6E, annular baffle 200 has axially extending wire guide apertures 210 which receive phase wires of stator windings 60 that pass through certain slots 174, and insulates those wires from frame end member 26. Baffle/insulator 200 has axially upwardly open wire guide channels 212 into which wire guide apertures 210 open, and along which the wires are routed for connection to first and second phase signal terminals 194, 196 of electronics modules 186. FIG. 6D depicts a cross-sectional view of a wire-retention tab 214, a portion of which normally superposes a portion of wire guide channel 212. Wire retention tabs 214 are elastically deflected out of superposition with wire guide channel 212 to allow insertion of the phase wires into the channel, and then return to their natural, undeflected positions to retain the wires therein. Wire guide channels 212 may be of sufficient depth to permit vertical stacking therein of a plurality of stator phase wires in a direction parallel to axis 66. FIG. 6E depicts a cross-sectional view of wire guide channel 212 at a wire guide aperture 210.

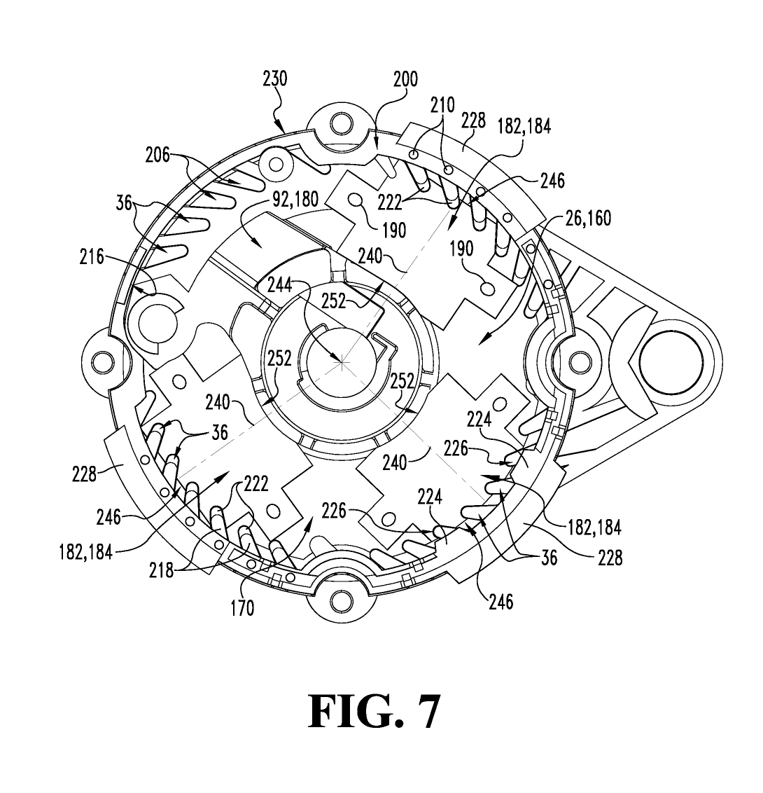

Projecting axially inwardly from the bottom of baffle 200 and extending radially inwardly relative to baffle radially inner surface 216 are protrusions 218 adapted to be received into cooperating slots 174. In the depicted embodiment, these cooperating slots 174 are axially aligned with wire guide apertures 210. As shown in FIG. 7, two sets of adjacent protrusions 218 are each generally radially aligned with the approximately diametrically opposed ones of frame end member heat sink portions 182. Protrusions 218 at least partially seal their respective cooperating slots 174 to better control the movement of cooling air through and from cover airflow space 38. Each protrusion 218 extends along its receiving slot 174, generally radially inwardly away from baffle radially inner surface 216 and towards second end 178 of the slot. Free, terminal end 220 of each protrusion 218 may, however, be spaced from its respective slot's second end 178, to permit some amount of airflow therebetween, if desired. In other words, each protrusion terminal end 220 and second end 178 of its associated slot 174 may define a first baffle gap 222 through which a metered quantity of cooling air may be drawn from cover airflow space 38 to frame airflow space 46. Cover air outlets 36 of machine 20 may thus include first baffle gaps 222.

Referring still to FIG. 7, baffle 200 may also include flat, radially inward projections 224 that extend from radially inner surface 216 for refining control of cooling airflow movement through and from cover airflow space 38. Projections 224 at least partially overlap second portions 206 of certain slots 174, and may define second baffle gaps 226, which may be included among cover air outlets 36 of machine 20. A projection 224 may superpose slot second portions 206 circumferentially bounded by opposing sides of an electronics module mounting surface 184.

Baffle 200 may have radially outwardly extending air vectoring walls 228 projecting from its radially outer surface 230 at locations substantially radially aligned with the positions of electronic modules 186. Air vectoring walls 228 guide the flow of cooling air once exhausted from frame air outlets 44 radially outwardly and forward, in directions away from cover 30 and cover inlet 32, to help ensure that cooling air exhausted from frame air outlets 44 is not recirculated back into cover and frame airflow spaces 38, 46, and to help ensure that the heat of the exhausted air is not transferred through cylindrical cover side wall 134 to regions of cover airflow space 38 proximate to modules 186.

As described above, frame airflow space 46 is located between frame air inlet 42 and frame air outlets 44, and cover 30 overlies and engages frame end member 26, preferably through baffle 200, to form air outlets 36 from cover airflow space 38. During machine operation, cooling air in frame airflow space 46 downstream of fan 104, flowing under the influence of fan 104 at high speed (relative to air movement through cover airflow space 38) towards frame air outlets 44, passes second portions 206 of slots 174 (i.e., cover air outlets 36) and interacts with relatively slower moving air in cover airflow space 38 to produce a venturi effect and draw the slower moving air into combination with the faster moving air through cover air outlets 36.

Those of ordinary skill in the relevant art well-understand the venturi effect, which is employed in machine 20 as a function of fluid pressure and flow velocity differences between cooling air located on opposite sides of cover air outlets 36. Particularly, a first portion of cooling air enters frame airflow space 46 through frame air inlet 42 and is expelled radially from frame airflow space 46, under force imparted by fan 104, through frame air outlets 44. Meanwhile, a second portion of cooling air is received into cover airflow space 38 from cover air inlet 32 and is caused to be drawn, under a venturi effect, through cover air outlets 36 and into frame airflow space 46 by the first portion of cooling air being directed past cover air outlets 36 within frame airflow space 46. The second portion of cooling air is combined with the first portion, and the combined first and second cooling air portions are expelled from machine 20 through frame air outlets 44.

More particularly, the first portion of cooling air flowing through frame airflow space 46 and directed towards frame air outlets 44 is at a first pressure and a first velocity as it passes across the exit from cover air outlets 36. The second portion of cooling air at the entrance to cover air outlets 36 within cover airflow space 38 is at a second pressure comparatively greater than the first pressure and a second velocity comparatively less than the first velocity. These relative pressure and velocity conditions induce a venturi effect across cover air outlets 36, which causes the second portion of cooling air to be drawn through cover air outlets 36 and into combination with the first portion of cooling air. The combined first and second portions of cooling air are together exhausted from machine 20 through frame air outlets 44.

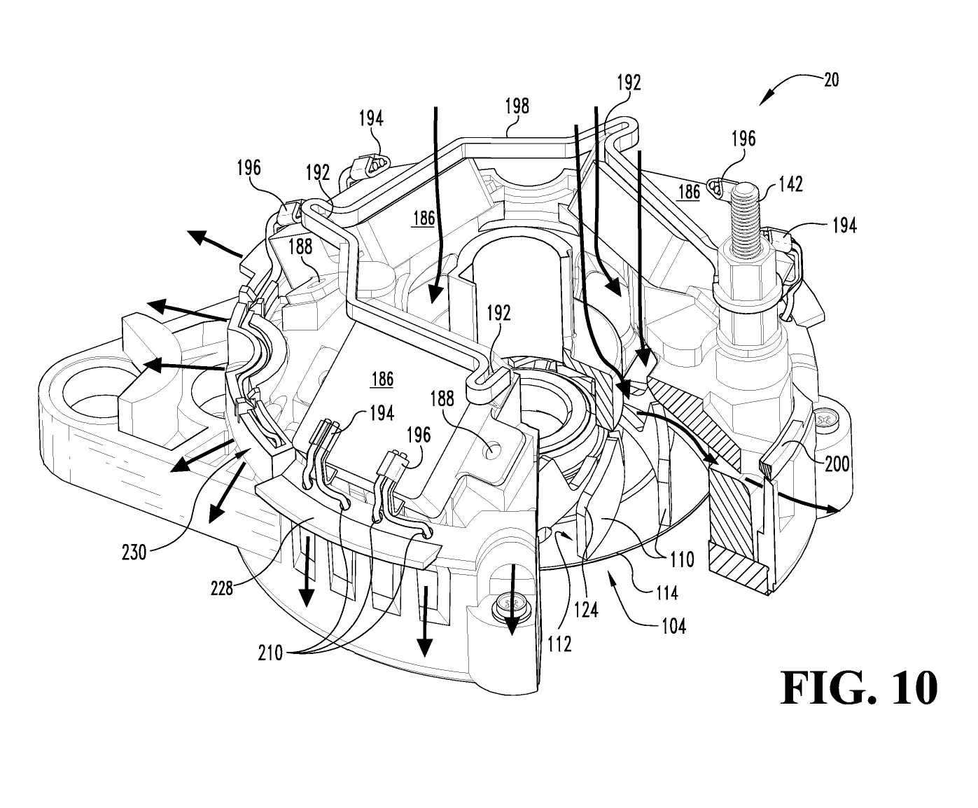

As will also be understood by one of ordinary skill in the relevant art, movement of the second portion of cooling air from cover airflow space 38 through cover air outlets 36 reduces the pressure of cooling air within cover airflow space 38 near the entrances to cover air outlets 36. This pressure reduction induces the flow of cooling air from inside of cover air inlet 32 into and through cover airflow space 38 on a continual basis during operation of machine 20, creating the airflow within cover airflow space 38. FIG. 10 shows machine 20 with its cover 30 omitted, and illustrates the flow of air through frame airflow space 46.

It is to be understood that while preferably to include baffle 200 in machine 20 to seal cover 30 to frame end member 26, control the flow of cooling air within and from cover airflow space 38, and from frame air outlets 44, and to insulate and wires of stator winding 60 and route them to module terminals 194, 196, it is envisioned that baffle 200 may be omitted from certain non-depicted embodiment of machine 20. In such embodiments, cover axially inner rim 136 may operably engage external surface 160 of frame end member 26 directly, for example at the sites of its baffle ledge portions 202, with a venturi effect inducing airflow from cover airflow space 38 to frame airflow space 46 through cover air outlets 36 remaining substantially as described above.

The second portion of cooling air flowing through cover airflow space 38 is convectively warmed by relatively warmer surfaces within cover airflow space 38 (e.g., by surfaces of frame end member 26, electronics modules 186, and regulator master 90). The continuous flow of cooling air through cover airflow space 38, which may be controlled as described above, flushes the warmed air from about those surfaces and from cover airflow space 38. The first portion of cooling air received into frame airflow space 46 convectively cools bearing support 70, interior surface 162 of frame end member 26, and the end turns 62 of stator windings 60 that are enclosed by frame end member 26.

In this regard, the advantage of machine 20 over prior rotary electric machines is readily apparent. FIG. 9A depicts a partial cross-section of a prior alternator 20P that includes frame end member 26P having backface portion 170P defining opposing, parallel exterior and interior surfaces 160P, 162P. Exterior surface 160P includes thermally conductive mounting surfaces 184P to which electronics are affixed. The electronics may be partially cooled convectively by airflow passing over them within cover airflow space 38P. Heat from the electronics is also transferred conductive to backface portion 170P through surfaces 184P of backface portion exterior surface 160P. A portion of the electronics cooling thus entails convective heat transfer from surfaces 160P, 162P to airflow through machine 20P.

Cover 30P, having central cover air inlet 32P and side air inlet 232 is sealably engaged with frame end member 26P to define cover airflow space 38P between the interior surface of the cover 30P and backface portion exterior surface 160P. Alternator 20P includes frame air inlet 42P formed between the outer cylindrical surface of bearing support portion 72P and radially inner rim 164P of backface portion 170P. Frame airflow space 46P is defined between frame air inlet 42P and frame air outlets 44P. During operation of machine 20P, its fan draws cooling air though both central cover opening 32P and side air inlet 232, and through frame air inlet 42P. Frame air inlet 42P is defined by a radial gap of distance D1P between the outer cylindrical surface of bearing housing portion 72P and annular radially inner rim 164P of backface portion 170P.

Notably, air ingested into frame airflow space 46P is previously warmed by a part of it having been circulated through cover airflow space 38P, about the electronics packaged therein, and across backface portion exterior surface 160P. In other words, frame air inlet 42P also serves as the outlet from cover airflow space 38P. Cooling airflow drawn into machine 20P through central air inlet 32P and side air inlet 232, and passing through cover airflow space 38P, is warmed in cover airflow space 38P before being drawn, in combination with other, comparatively unwarmed cooling air received into machine 20P through central air inlet 32P, into dual purpose frame air inlet/cover air outlet 42P, which is a direct axial opening that limits the flow of air into frame airflow space 46P to the axial direction immediately upstream of the fan, causing the incoming airflow to impinge upon fan face 112P. The combined airflow drawn into frame air inlet/cover air outlet 42P, having already been partially warmed, undesirably raises the bulk temperature of the combined airflow in frame airflow space 46P relative to that drawn into cover air inlets 32P, 232, consequently reducing the ability of cooling air passing through frame airflow space 46P to convectively absorb heat from backface portion interior surface 162P and stator windings 60P. In machine 20, however, the first and second portions of cooling air absorb heat individually, whereby the ability of neither portion to absorb heat is adversely affected by the increased temperature of the other.

Furthermore, in addition to the above shortcomings of machine 20P, the inclusion of side air inlet 232 in cover 30P may permit warmed air exhausted through frame air outlets 44P to be recirculated back into cover airflow space 38P into the side air inlet 232, which increases the temperature of the cooling air received therein. Single, centrally located cover air inlet 32 of machine 20 mitigates that possibility, especially if the cover air inlet is ducted as described above.

Referring to FIG. 9E, in machine 20 surface 102 of bearing support cylindrical neck portion 76 and radially inner rim 164 of frame frustoconical portion 170 are radially spaced by distance D1; this gap defines frame air inlet 42. Surface 100 of cylindrical bearing housing portion 72 of bearing support 70 and radially inner rim 164 may or may not be radially spaced: In FIG. 9B they are not; in FIG. 9C they are separated by radial distance D2. Shoulder 78 of bearing support 70 is axially spaced forwardly of radially inner rim 164 by distance D3, as shown in FIG. 9E. Thus, central airflow space 40 includes portions of frame airflow space 46 upstream of fan 104 that are located axially inward of rim 164, which defines frame air inlet 40, and between frame frustoconical portion 170 and bearing support 70. FIG. 9E shows that radially outmost edge 234 of cover air inlet 32 and cylindrical neck portion surface 102 are radially separated by distance D4, whereby cover air inlet 32 extends slightly beyond the perimeter of frame air inlet 42. Consequently, a direct, axial airflow path for cooling air is provided from central cover opening 32 to central airflow passage 40 towards fan 104. Distance D4 also places the radially outermost edge 234 of cover air inlet 32 radially outside of rim 164, facilitating the influx of cooling air into cover airflow space 38.

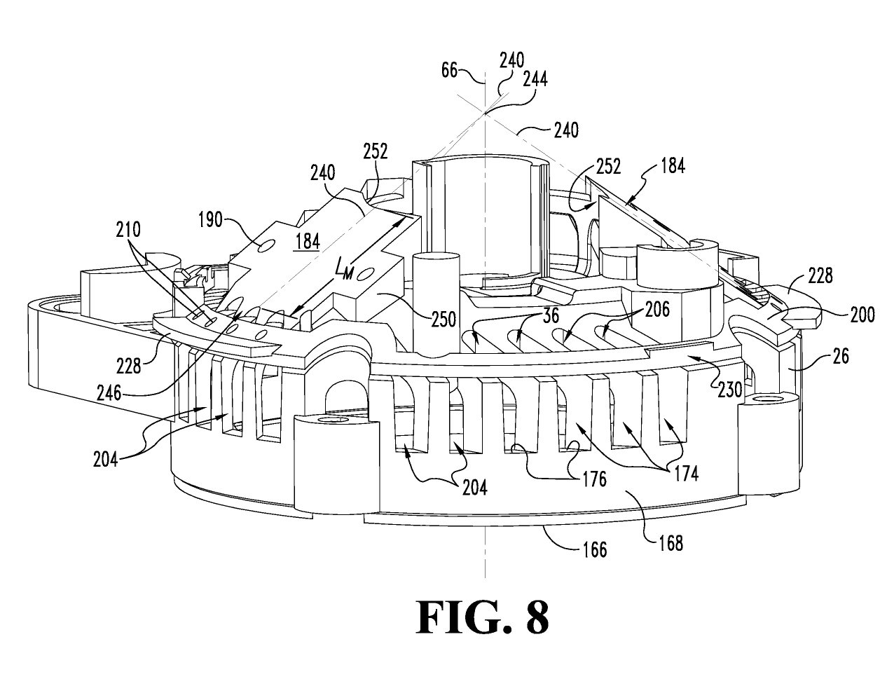

Referring to FIGS. 8 and 9D, each heat sink portion mounting surface 184 is planar and is tilted at angle 242 relative to an imaginary plane that is perpendicular to central axis 66. The center of each mounting surface 184 lies along a midline 240 that is directed axially outwardly and radially inwardly towards central axis 66; the midlines 240 and central axis 66 intersect rearwardly of frame end member frustoconical portion 170, at convergence point 244. Except for slot second portions 206, which may be restricted by baffle 200 as described above, frame end member 26 frustoconical portion 170 is substantially impermeable to airflow between frame end member exterior and interior surfaces 160, 162 radially outside of inner rim 164.

Midlines 240 define the surface of an imaginary right circular cone whose apex coincides with convergence point 244. Each planar mounting surface 184 is tangential to the surface of the imaginary right circular cone and has a midline dimension L_{M} (FIG. 6A) along its respective midline 240 between radially inner rim 164 and radially outermost nominal edge 246 of the respective mounting surface 184. Therefore, mounting surfaces 184 are each sloped relative to central axis 66 at vertex angle θ, as best seen in FIGS. 9D and 9E. Thus, above-mentioned angle 242 is defined by n/2−θ or 90°−θ.

Vertex angle θ may be in the range between 20° and 70°, i.e., 20°≦θ≦70°. In certain embodiments, vertex angle θ is in the range between 45° and 70°, i.e., 45°≦θ≦70°. In certain other embodiments, vertex angle θ is in the range between 50° and 60°, i.e., 50°≦θ≦60°. The projection of a mounting surface midline dimension L_{M} rearwardly in a direction parallel to central axis 66 from an imaginary plane perpendicular to the central axis and, for example, intersecting the juncture between frame end member cylindrical and frustoconical portions 168, 170, decreases as vertex angle θ decreases. This is described in equation (1), wherein R₁ is the radial distance from axis 66 to inner rim 164, and R₂ is the radial distance from axis 66 to mounting surface edge 246:

$${L}_{m} ∝ [ \frac{{R}_{2} - {R}_{1}}{sin θ} ] \qquad ( 1 )$$

The area of each mounting surface 184 is generally proportional to dimension L_{M}. As shown, mounting surfaces 184 are generally rectangular. Thus, while substantially maintaining their respective widths, perpendicular to midline 240, substantially constant as midline dimension L_{M} of mounting surfaces 184 increases, the area of mounting surface 184 also increases. Those of ordinary skill in the art will recognize that dimension L_{M} of each mounting surface 184 may be increased along midline 240, thereby increasing its respective surface area, by decreasing vertex angle θ while holding R₁ and R₂ constant.

As an example, with the difference between R₁ and R₂ fixed, and radial frame air inlet gap distances D1 and D1P substantially equal, for a vertex angle θ equal to 55°, the midline dimension L_{M}, of mounting surface 184 is increased by about twenty-two percent (22%) relative to L_{M} of orthogonal module mounting surface 184P of prior alternator 20P shown in FIG. 9A, which has a 90° vertex angle. This increase in the midline dimension L_{M} in machine 20 relative to machine 20P is accomplished without changing the diameter of frame cylindrical portion 168 relative to frame cylindrical portion 168P or the distance D1 of the radial gap that defines frame air inlet 42 relative to distance D1P that defines frame air inlet 42P. Therefore, one of ordinary skill in the art will understand that, under this scenario L_{M} would be smaller in prior machine 20P than in machine 20, and the area of mounting surfaces 184P for power electronics would be proportionally less than that of mounting surfaces 184. Relative to prior machine 20P, machine 20 therefore has an advantage in that it provides larger conductive and convective heat transfer surfaces.

In machine 20 at least some edges of mounting surfaces 184 may be substantially flush with frame end member exterior surface 160 at locations between heat sink portions 182. Alternatively, as shown, heat sink portions 182 include peripheral side surfaces 250 which project from frame end member exterior surface 160 at those locations. Referring to FIGS. 7 and 8, the peripheral side surfaces 250 of each heat sink portion 182 may include radially inner surface portion 252 that is scalloped to define curved, annular frame inner rim 164 and minimize protrusion of heat sink portions 182 into central airflow passage 40.

Electronic modules 186 are positioned to minimally interfere with cooling airflow entering from cover inlet 32, and their bottom, heat-conducting surfaces are preferably located entirely within the bounds of mounting surfaces 184. In some embodiments of machine 20, a portion of at least one of electronic modules 186 can overhang scalloped, radially inner surface portion 252 of heat sink portion 182 as shown in FIG. 9C, without substantially restricting frame air inlet 42, by reducing vertex angle θ.

Moreover, the shape or slope of the interior surface 162 may be configured to maximize convective heat transfer between the frustoconical portion 170 and cooling air passing over interior surface 162, substantially independently of the shape or slope of exterior surface 160, particularly of its mounting surfaces 180 and 184, which may be configured to maximize conductive heat transfer from regulator master 90 and electronic modules 186 to frame end member 26.

The thicknesses of frame end member 26 need not be uniform along midlines 240; the angular dispositions of frame end member exterior and interior surfaces 160, 162 on frustoconical portion 170 may differ somewhat relative to the imaginary right circular cone. For example, interior surface 162 may be substantially disposed on a similar imaginary cone whose vertex angle β (shown in FIG. 9D relative to cylindrical surface 102, which parallels axis 66) differs from vertex angle θ. Vertex angle β may, for example, be in a range between 10° and 80°, i.e., 10°≦β≦80°. In certain embodiments, vertex angle β is in a range between 15° and 60°, i.e., 15°≦β≦60°. In certain other embodiments, vertex angle β is in a range between 25° and 45°, i.e., 25°≦β≦45°. In some embodiments, interior surface 162 of frame end member frustoconical portion 170 may curve, and have different slopes, in directions parallel to central axis 66. In that case, vertex angle β may be averaged over its length in those directions. Furthermore, portions of frame end member exterior surface 160 located between heat transfer portions 182 may be sloped relative to axis 66 at angles that differ from vertex angles θ or β.

In machine 20P, cooling air is received into frame airflow space 46P along an airflow path that is limited to being axially directed. The axial momentum of the cover air flow may cause a portion of the cooling air to directly impinge upon fan face 112P of the fan, which increases turbulence and induces eddy currents within frame airflow space 46P, as depicted by the curved, arrow-headed dot-dashed lines of FIG. 9A. In addition, because a portion of the cooling air impinges directly on fan face 112P, the airflow through frame air inlet 42P experiences a pressure loss as it enters the area around the fan. This pressure loss decreases the cooling air exchange efficiency through machine 20P. For example, direct axial frame air inlet 42P does not allow the cooling air to begin turning in radially outward directions before entering frame airflow space 46P upstream of the fan, which reduces the momentum of the cooling airflow received axially into frame airflow space 46P before being accelerated radially by the fan towards frame air outlets 44P. Beneficially, In alternator 20 the axial distance between radially inner rim 164 and shoulder 78 of bearing support 70 permits a substantially greater portion of frame central airflow passage 40 to be located axially inward of frame end member interior surface 162, vis-à-vis alternator 20P, as shown be direct comparison of FIGS. 9A with 9B and 9C. Indeed, in prior alternator 20P, radially inner rim 164P is located axially inward of shoulder 78.

Generally, for a given radial gap distance D1, restrictions to airflow within central airflow space 40 will be reduced, and fan efficiency thus increased, by decreasing vertex angle β. Additionally, frame end member interior surface 162 is contoured proximate radially inner rim 164 to smoothly transition the flow of cooling air within frame airflow space 46, from a generally axial direction to directions having radial components, as the airflow approaches fan 104. Referring to FIGS. 9B-9E, frame frustoconical portion 170 has a rounded profile that extends axially inward and radially outward from frame air inlet 42 as inner rim 164 smoothly transitions to interior surface 162. The rounded profile continues axially inward and radially outward, defining interior surface 162 until surface 162 conforms to the above-mentioned conical shape having vertex angle β. This rounded profile defines smooth, transitional wall portions 256 of frame airflow space 46. Transitional wall portions 256 of interior surface 162 are located beneath or opposing mounting surfaces 184, as shown in 9B-9E, but may also be beneath, or opposing regulator master mounting surface 180 and extend about the periphery of inner rim 164 between support members 172, as indicated in FIG. 4.

Transitional wall portion(s) 256 slants away or diverges from bearing support 70 in axially inward and radially outward directions. Referring to FIG. 9D, in an imaginary plane in which central axis 66 lies, a line tangent to the curved profile of transitional wall portion 256 is oriented such that it forms varying frame airflow entry angle φ relative to central axis 66 at different locations of transitional wall portion convergence point 258 along axis 66. Frame airflow entry angle φ increases as the transitional wall portion convergence point 258 moves axially inwardly along axis 66, to a maximum angle that coincides with vertex angle β, i.e., φ≦β. Frame airflow entry angle φ and vertex angle β may be selected, independently of vertex angle θ, to optimize the size of frame central airflow space or passage 40 and thereby conserve the momentum of airflow through frame assembly 24 as it transitions from movement in an axial direction at frame air inlet 42, to movements in radial directions downstream of fan 104, thereby increasing the air exchange efficiency of fan 104 in alternator 20 relative to prior alternator 20P.

The air exchange efficiency of fan 104 is improved in alternator 20, vis-à-vis alternator 20P, first by providing frustoconical portion 170 having a substantially conical interior surface 162, and also by selecting frame air entry angles φ that smooth the transition from axial to radial airflow within frame airflow space 46. In prior alternator 20P, as typical of prior machines, frame airflow space 46P is defined by frame end member interior surface 162P that is oriented substantially orthogonally relative to central axis 66, and has sharp-cornered transitional edge 256P at radially inner rim 164P, as shown in FIG. 9A. Relative to machine 20P, machine 20 facilitates comparatively greater bulk airflow through its frame airflow space 46 and, by reducing the volume of cooling air that impinges upon fan face 112 before fan 104 accelerates the cooling air in a radial direction, increases the power efficiency of fan 104. A comparison of airflow paths through prior machine 20P (FIG. 9A) and machine 20 (FIGS. 9B-9E) indicated by arrow-headed dot-dash lines shows that providing frustoconical portion 170 and transitional wall portion(s) 256 according to the present disclosure forms a bend 260 in the path from central airflow passage 40 that is relatively more gradual and more smoothly turns the flow of cooling air passing through frame airflow space 46.

In machine 20, the cooling air drawn through central airflow passage 40 passes along large axial gap D3 (FIG. 9E) before encountering shoulder 78. By virtue of shoulder 78 and bearing housing portion cylindrical surface 100 being generously spaced from interior surface 162, the cooling air moves substantially unrestrictedly past shoulder 78 and along slanted interior surface 162, and is directed through gradual bend 260 as it transitions from a generally axially directed flow direction upstream of fan 104 to a generally radially directed flow direction downstream of fan 104. This facilitates a reduction in cooling airflow impingement on fan face 112 relative to that which occurs in machine 20P. Consequently, the solely axially directed momentum of the cooling air drawn towards fan 104 is gradually reduced, and radially directed momentum is gradually increased, as the airflow moves through bend 260 before being accelerated by fan 104 to the higher velocity with which it passes cover air outlets 36 and is exhausted through frame air outlets 44.

The combination of large-radii bend 260 and large axial gap D3 between rim 164 and shoulder 78 tends to minimize undesirable airflow eddy currents or turbulence experienced in prior machine 20P and, in turn, preserves the momentum of airflow received into central airflow space 40 as the airflow continues its passage through frame airflow space 46. Relative to machine 20P, the increased conservation of airflow momentum may increase the airflow velocity of the exhaust air towards and through the frame air outlets 44, minimizes eddy currents or turbulence within frame airflow space 46, and facilitates a strong suction force on cover air outlets 36 to draw warmed air from cover airflow space 38.

Accordingly, frame frustoconical portion 170 advantageously increases the available surface area to which electronic modules 186 may be mounted, and beneficially configures central airflow passage 40 such that the airflow path through frame airflow space 46 is not limited substantially to being only directly axial and directly radial, which would undesirably interrupt the momentum of cooling air flowing therethrough.

Referring to FIG. 9D, the portion of cover interior surface 130 associated with cover frustoconical portion 138 defines an imaginary right circular cone whose vertex coincides with cover convergence point 262 located on axis 66; the cover vertex angle Γ may differ from vertex angles θ and/or β, but may be substantially equal to either.

Mounting surfaces 184 position the axially outermost edges 264 of their respective electronic modules 186 in proximity to portions of cover interior surface 130 associated with cover top wall 98, presenting cover gaps 266 through which cooling airflow is restricted within cover airflow space 38. Apart from other modifications such as to cover 30, modules 186 or their edges 264, and/or the positioning of modules 186 relative to frame frustoconical portion 170, providing a suitable cover gap 266 is also a consideration in selection of an appropriate vertex angle θ.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An electric machine, comprising:
a rotor and a stator operably coupled with the rotor;
electronic components;
a drive shaft disposed along a central axis of the machine;
a bearing support supportively surrounding the drive shaft; and
a frame end connected to the stator and comprising a backface portion to which the electronic components are mounted, the backface portion defining a frame airflow space through which cooling air can flow;
wherein the backface portion is sloped relative to the central axis and defines a frame air inlet through which cooling air is received into the frame airflow space, the frame air inlet located between the bearing support and the backface portion.

2. The electric machine of claim 1, wherein the backface portion is substantially frustoconical, and has opposing exterior and interior surfaces, the electronic components mounted to the backface portion exterior surface, the backface portion interior surface defining the frame airflow space, the frame air inlet disposed about the central axis.

3. The electric machine of claim 2, wherein the backface portion exterior surface is sloped relative to the central axis at an angle between about 20° and about 70°.

4. The electric machine of claim 2, wherein the backface portion exterior surface is sloped relative to the central axis at an angle between about 45° and about 70°.

5. The electric machine of claim 2, wherein the backface portion exterior surface is sloped relative to the central axis at an angle between about 50° and about 60°.

6. The electric machine of claim 2, wherein the backface portion interior surface is sloped relative to the central axis at an angle between about 10° and about 80°.

7. The electric machine of claim 2, wherein the backface portion interior surface is sloped relative to the central axis at an angle between about 15° and about 60°.

8. The electric machine of claim 2, wherein the backface portion interior surface is sloped relative to the central axis at an angle between about 25° and about 45°.

9. The electric machine of claim 1, wherein the backface portion defines a radially inner rim at which the frame air inlet is located, the frame end comprises a cylindrical portion connected to the backface portion and extending between the stator and the backface portion with frame air outlets located in the cylindrical portion, and the frame airflow space extends between the frame air inlet and the frame air outlets.

10. The electric machine of claim 9, wherein the frame air outlets are defined by a plurality of circumferentially distributed slots in the frame end, the slots having a first end located in the cylindrical portion and an opposite second end located in the frustoconical portion.

11. The electric machine of claim 10, comprising a cover overlying the frame end and having a cover air inlet substantially surrounding the central axis through which cooling air is receivable into the machine, the cover and the frustoconical portion exterior surface defining a cover airflow space extending between the cover air inlet and cover air outlets through which cooling air is receivable from the cover airflow space into the frame airflow space.

12. The electric machine of claim 11, wherein the cover has a rim operably engaged with the frame end, the cover air outlets located between the frame air outlets and the slot second ends.

13. The electric machine of claim 1, wherein the backface portion is sloped relative to the central axis at an acute angle.

14. The electric machine of claim 1, wherein the frame air inlet defines a circumferential opening surrounding the central axis.

15. The electric machine of claim 1, further comprising a cover connected to the frame end and defining a cover airflow space in which the electronic components are disposed and cover air outlets, and wherein the frame airflow space extends between the frame air inlet and a plurality of frame air outlets, each of the cover air outlets is paired with a respective one of the plurality of frame air outlets, the cover includes a cover air inlet through which is receivable a first portion of cooling air that is subsequently receivable into the frame airflow space and a second portion of cooling air that is subsequently receivable into the cover airflow space, and the first and second portions of cooling air are separated from each other between the frame air inlet and the cover air outlets.

16. The electric machine of claim 15, wherein the cover air inlet is disposed centrally with respect to a radial center of the machine.

17. The electric machine of claim 15, wherein the cover and frame end together define an airflow path for the first portion of cooling air that extends axially from the cover air inlet to the frame air inlet, then bends at an angle of less than 90° relative to the central axis within the frame airflow space while extending along the underside of the end frame to cool the electronic components, and then in combination with the second portion of cooling air is exhausted from the machine.

18. An electric machine, comprising:
a rotor and a stator operably coupled with the rotor;
a drive shaft disposed along a central axis of the machine;
a frame end arranged at an end of the stator, the frame end including a backface portion having electronic components mounted thereto, a bearing support structure in which the drive shaft is mounted, and frame air outlets that allow heated air to escape the machine;
a cover connected to the backface portion and overlying the backface portion, the cover including a cover air inlet that allows cooling air to enter the machine, the cover and the frame end defining cover air outlets;
a first airflow path extending from the cover air inlet to the frame air outlets, the first airflow path being aligned substantially parallel to the central axis at the location of the cover air inlet and having a bend of less than 90° relative to the central axis before terminating at the frame air outlets; and
a second airflow path extending from the cover air inlet to the cover air outlet through a cover airflow space in which the electronic components are located, the second airflow path exiting the cover airflow space through the cover air outlets, the second airflow path brought into combination with the first airflow path at the cover air outlets.

19. The electric machine of claim 18, wherein the backface portion is sloped relative to the central axis and the frame end defines a central airflow space between the backface portion and the bearing support structure in which the bend is located.

20. A method of enhancing the cooling of electric components of an alternator of the type having a bearing support structure in which a drive shaft defining the alternator central axis is mounted and a frame end backface portion to which the electronic components are mounted, the method comprising sloping the backface portion relative to the central axis to thereby define a frame airflow space having a frame air inlet located between the backface portion and the bearing support structure through which air to cool the electronic components can flow.
